(19) United States
(12) Patent Application Publication
(10) Pub. No.: US 2026/0300590 A1
(43) Pub. Date: Oct. 1, 2026

(54) NET NAME SWAP IN NETLIST OF CIRCUIT SYSTEM

(71) Applicant: International Business Machines Corporation, Armonk, NY (US)

(72) Inventors: Faisal HASAN, Austin, TX (US); Alexander LAICHINGER, Baden-Wuerttemberg (DE); Philipp RÖDER, Mannheim (DE)

(21) Appl. No.: 19/092,322

(22) Filed: Mar. 27, 2025

(51) Int. Cl. G06F 30/323; G06F 30/394; G06F 119/12

(52) U.S. Cl. CPC G06F 30/323; G06F 30/394; G06F 2119/12

(57) ABSTRACT

In some implementations, a computer system may determine that a first net has experienced a timing failure in a circuit of a hierarchical large block synthesis (HLBS) system. The computer system may select a second net in the circuit that has better timing properties than the first net. The computer system may swap, in a stored netlist, a first net name of the first net a second net name of the second net in association with swapping endpoint connection locations of the first net and endpoint connection locations of the second net. The computer system may update routing information in the stored netlist to connect endpoints of the first net and endpoints of the second net.

### BACKGROUND

This disclosure relates to circuit systems, and more specifically, to a circuit system of a design type or methodology.

### SUMMARY

Some implementations described herein relate to a method. The method may include determining that a first net has experienced a timing failure in a circuit of a circuit system. The method may include selecting a second net in the circuit that has better timing properties than the first net. The method may include swapping, in a stored netlist, a first net name of the first net a second net name of the second net in association with swapping endpoint connection locations of the first net and endpoint connection locations of the second net. The method may include updating routing information in the stored netlist to connect endpoints of the first net and endpoints of the second net.

Some aspects described herein relate to a computer system. The computer system may include a processor set, one or more computer-readable storage media, and program instructions stored on the one or more computer-readable storage media to cause the processor set to perform operations. The operations may include evaluating existing timing properties of a circuit system. The operations may include identifying a set of timing failures of the circuit system that require wire-only fixes. The operations may include categorizing a set of nets associated with the set of timing failures by distance, wire characteristic, and time of flight. The operations may include determining a subset of nets with better timing properties than the set of nets. The operations may include swapping names of wires in the subset of nets in association with a swap of end connections of the wires. The operations may include confirming that timing properties of new source-wire-load combinations are better than the existing timing properties of the system after removal of net segments that are no longer part of the main source-to-sink wire path.

Some aspects described herein relate to a computer program product. The computer program product may include one or more computer-readable storage media and program instructions stored on the one or more computer-readable storage media to perform operations. The operations may include evaluating existing timing properties of an hierarchical large block synthesis (HLBS) system. The operations may include identifying a set of timing failures that require wire-only fixes. The operations may include categorizing nets associated with the timing failures by distance, wire characteristic, and time of flight. The operations may include selecting a subset of nets with better timing properties. The operations may include swapping names and connections of wires in the subset of nets. The operations may include rerouting remaining open nets after removal of any net segments that are no longer part of main source-to-sink wire path.

### BRIEF DESCRIPTION OF THE DRAWINGS

FIG. 1 is a diagram of an example computing environment for net name swapping described herein.

FIG. 2 is a diagram of a portion of circuit of a hierarchal large block synthesis.

FIGS. 3A-3C are diagrams illustrating an example implementation associated with net name swapping.

FIG. 4 is a flowchart of an example process associated with a net name swap.

FIG. 5 is a flowchart of an example process associated with a net name swap.

FIG. 6 is a flowchart of an example process associated with a net name swap.

### DETAILED DESCRIPTION

The following detailed description of example implementations refers to the accompanying drawings. The same reference numbers in different drawings may identify the same or similar elements.

Designing and manufacturing complex microprocessors involves numerous intricate processes, including the routing of millions of nets (connecting networks or wires) to facilitate communication between various components. As the demand for faster, more efficient, and smaller devices continues to rise, designers face the increasingly difficult challenge of optimizing net routing to meet timing requirements while minimizing congestion. In large hierarchical designs, such as an HLBS system, resolving timing failures due to wire congestion becomes particularly arduous, often necessitating manual intervention.

Manual wire rerouting to resolve timing issues is a time-consuming and labor-intensive process, prone to introducing new errors or causing collateral damage to the surrounding design structure. This method involves deleting the original wire, manually rerouting it through densely packed areas, and potentially affecting multiple other nets in the process. This method is not only inefficient but also risky, as it may lead to additional timing issues or design rule check errors. Furthermore, as the complexity and density of chip designs continue to grow, the limitations of traditional rerouting techniques become more pronounced.

In some implementations described herein, a computer system may provide a net swap method that accelerates net repair and net rerouting in complex microprocessor designs. For example, the computer system may determine that a first net has experienced a timing failure, select a second net with better timing properties, and swap their net names to optimize timing performance. The net swap may be part of an engineering change order (Eco) routing net swap.

In some aspects, the computer system may account for removal of any net segments that are no longer part of the main source-to-sink wire path, reroute remaining opens (e.g., open nets), and evaluate existing timing properties to determine the timing failure. For example, the computer system may update circuit layout data to account for the removal of any net segments. The computer system may update the routing information for connections or routing adjustments that are made to close the opens. Additionally, the computer system may select the second net based on a scoring function associated with wire similarity (electrical characteristics such as resistance and capacitance), proximity, and delay, and confirm that new timing properties resulting from the swap are better than previous timing properties (e.g., before the swapping).

In this way, computer system may reduce computational complexity associated with resolving timing failures due to wire congestion in circuit systems that follows a design style or methodology, such as HLBS systems. By automating wire-only fixes and minimizing manual intervention, the computer system decreases the number of iterations required to achieve timing closure, and reduces the utilization of processing resources, memory resources, and network resources. In this way, the net name swap may reduce time and conserve processing resources, memory resources, or network resources.

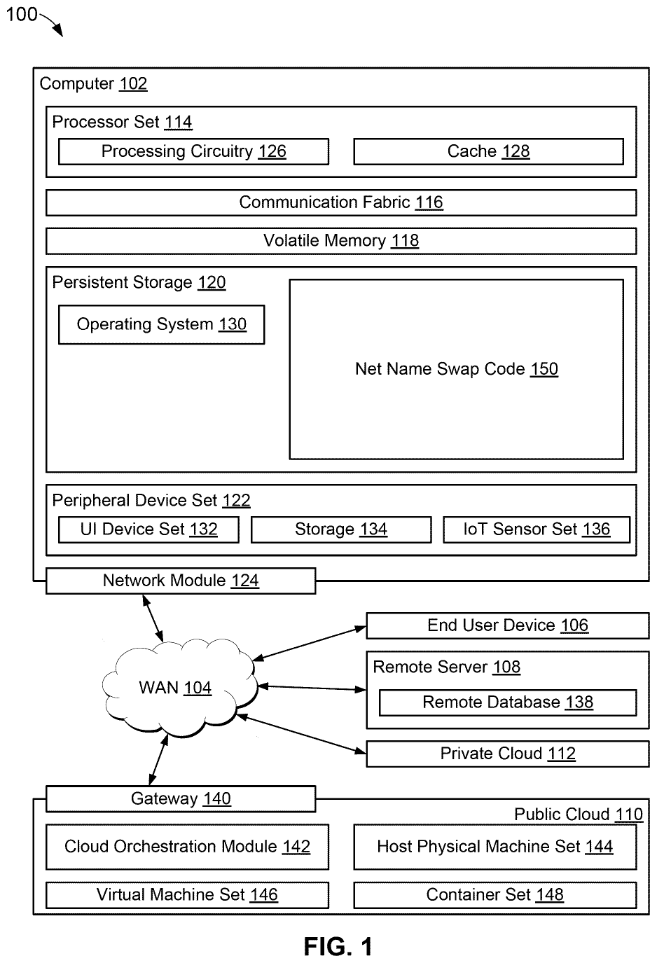

FIG. 1 is a diagram of an example computing environment 100 for net name swapping described herein.

Computing environment 100 contains an example of an environment for the execution of at least some of the computer code involved in performing the inventive methods, such as net name swap code 150. In addition to net name swap code 150, computing environment 100 includes, for example, computer 102, wide area network (WAN) 104, end user device (EUD) 106, remote server 108, public cloud 110, and private cloud 112. In this embodiment, computer 102 includes processor set 114 (including processing circuitry 126 and cache 128), communication fabric 116, volatile memory 118, persistent storage 120 (including operating system 130 and net name swap code 150, as identified above), peripheral device set 122 (including user interface (UI) device set 132, storage 134, and Internet of Things (IoT) sensor set 136), and network module 124. Remote server 108 includes remote database 138. Public cloud 110 includes gateway 140, cloud orchestration module 142, host physical machine set 144, virtual machine set 146, and container set 148.

Computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 138. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

Processor set 114 includes one, or more, computer processors of any type now known or to be developed in the future. Processing circuitry 126 may be distributed over multiple packages (for example, multiple, coordinated integrated circuit chips). Processing circuitry 126 may implement multiple processor threads and/or multiple processor cores. Cache 128 is memory that is located in the processor chip package(s) and is typically used for data or code that should be available for rapid access by the threads or cores running on processor set 114. Cache memories are typically organized into multiple levels depending upon relative proximity to the processing circuitry. Alternatively, some, or all, of the cache for the processor set may be located “off chip.” In some computing environments, processor set 114 may be designed for working with qubits and performing quantum computing.

Computer-readable program instructions are typically loaded onto computer 102 to cause a series of operational steps to be performed by processor set 114 of computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 128 and the other storage media discussed below. The program instructions, and associated data, are accessed by processor set 114 to control and direct performance of the inventive methods. In computing environment 100, at least some of the instructions for performing the inventive methods may be stored in net name swap code 150 in persistent storage 120.

Communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 118 is any type of volatile memory now known or to be developed in the future. Examples include dynamic type random access memory (RAM) or static type RAM. Typically, volatile memory 118 is characterized by random access, but this is not required unless affirmatively indicated. In computer 102, the volatile memory 118 is located in a single package and is internal to computer 102, but, alternatively or additionally, the volatile memory may be distributed over multiple packages and/or located externally with respect to computer 102.

Persistent storage 120 is any form of non-volatile storage for computers that is now known or to be developed in the future. The non-volatility of this storage means that the stored data is maintained regardless of whether power is being supplied to computer 102 and/or directly to persistent storage 120. Persistent storage 120 may be a read only memory (ROM), but typically at least a portion of the persistent storage allows writing of data, deletion of data, and re-writing of data. Some familiar forms of persistent storage include magnetic disks and solid-state storage devices. Operating system 130 may take any of several forms, such as various known proprietary operating systems or open source Portable Operating System Interface-type operating systems that employ a kernel.

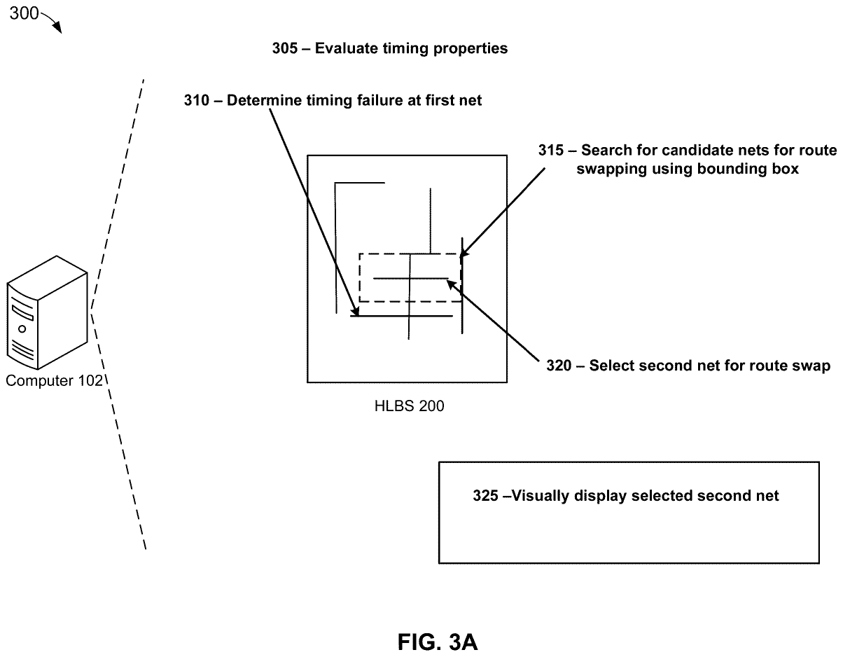

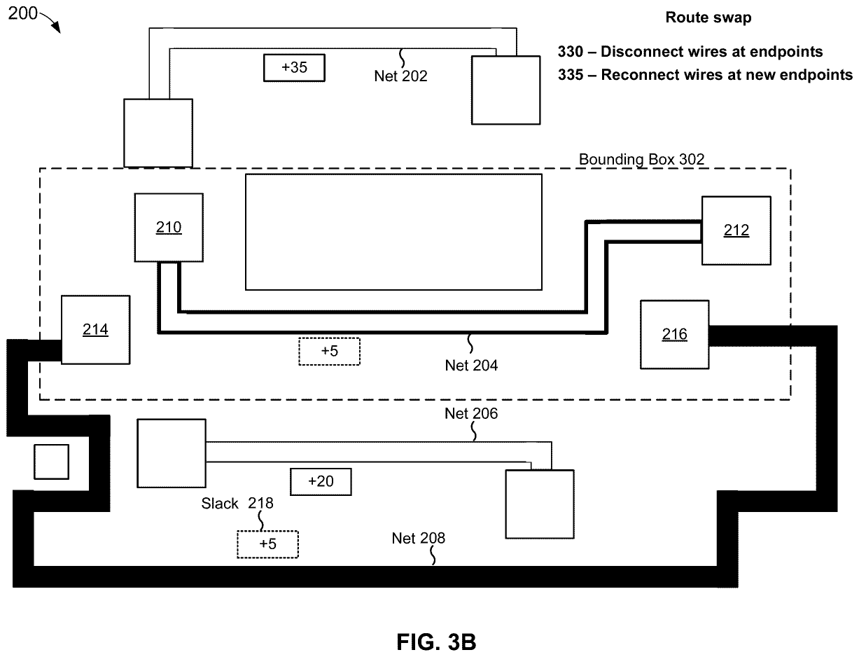

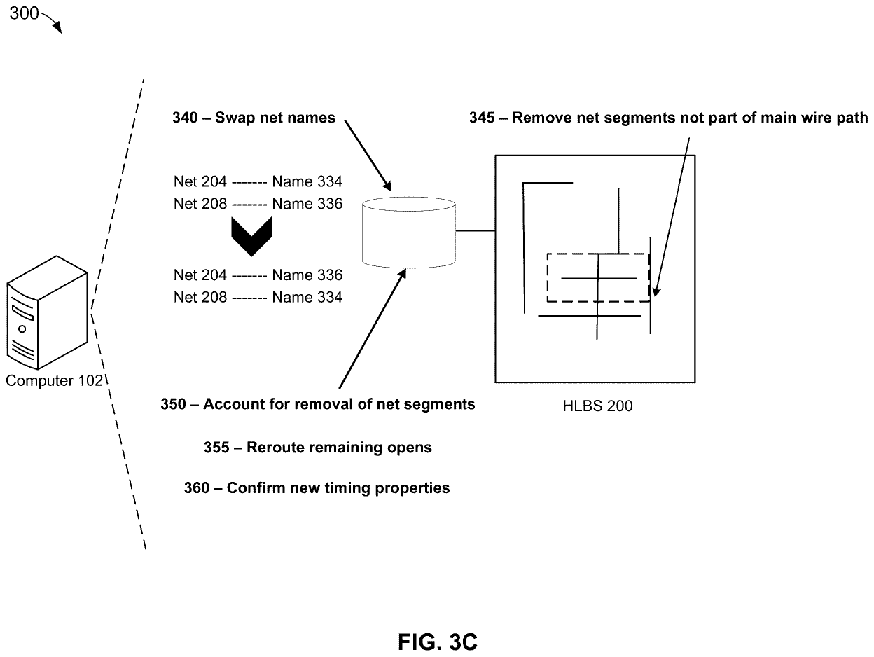

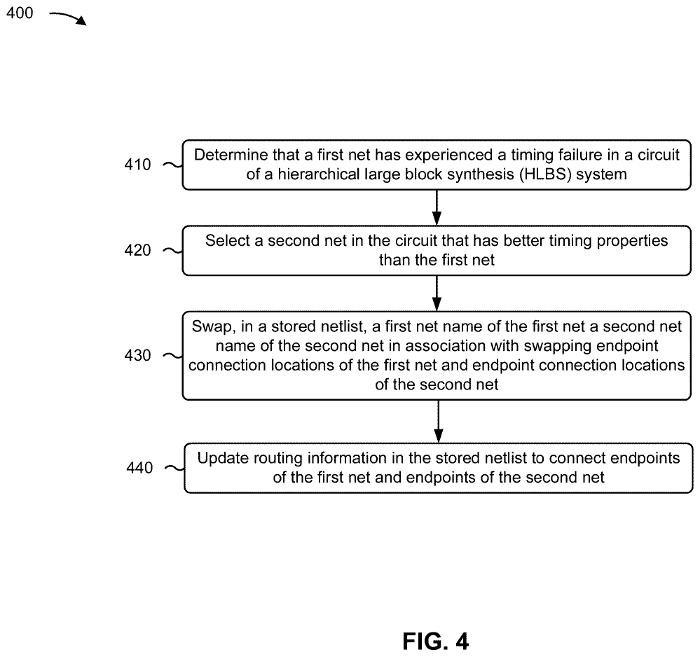

The code included in the net name swap code 150 typically includes at least some of the computer code involved in performing one or more operations described herein, such as the operations of implementation 300 in FIGS. 3A-3C and the processes described in FIGS. 4-6.

Peripheral device set 122 includes the set of peripheral devices of computer 102. Data communication connections between the peripheral devices and the other components of computer 102 may be implemented in various ways, such as Bluetooth® connections, Near-Field Communication (NFC) connections, connections made by cables (such as universal serial bus (USB) type cables), insertion-type connections (for example, secure digital (SD) card), connections made through local area communication networks and/or connections made through wide area networks such as the internet. In various embodiments, UI device set 132 may include components such as a display screen, speaker, microphone, wearable devices (such as goggles and smart watches), keyboard, mouse, printer, touchpad, game controllers, and/or haptic devices. Storage 134 is external storage, such as an external hard drive, or insertable storage, such as an SD card. Storage 134 may be persistent and/or volatile. In some embodiments, storage 134 may take the form of a quantum computing storage device for storing data in the form of qubits. In embodiments where computer 102 is required to have a large amount of storage (for example, where computer 102 locally stores and manages a large database), this storage may be provided by peripheral storage devices designed for storing very large amounts of data, such as a storage area network (SAN) that is shared by multiple, geographically distributed computers. IoT sensor set 136 is made up of sensors that can be used in Internet of Things applications. For example, one sensor may be a thermometer and another sensor may be a motion detector.

Network module 124 is the collection of computer software, hardware, and firmware that allows computer 102 to communicate with other computers through WAN 104. Network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 124 are performed on the same physical hardware device. In other embodiments (for example, embodiments that utilize software-defined networking (SDN)), the control functions and the forwarding functions of network module 124 are performed on physically separate devices, such that the control functions manage several different network hardware devices. Computer-readable program instructions for performing the inventive methods can typically be downloaded to computer 102 from an external computer or external storage device through a network adapter card or network interface included in network module 124.

WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and/or edge servers.

EUD 106 is any computer system that is used and controlled by an end user (for example, a customer of an enterprise that operates computer 102), and may take any of the forms discussed above in connection with computer 102. EUD 106 typically receives helpful and useful data from the operations of computer 102. For example, in a hypothetical case where computer 102 is designed to provide a recommendation to an end user, this recommendation would typically be communicated from network module 124 of computer 102 through WAN 104 to EUD 106. In this way, EUD 106 can display, or otherwise present, the recommendation to an end user. In some embodiments, EUD 106 may be a client device, such as thin client, heavy client, mainframe computer, desktop computer and so on.

Remote server 108 is any computer system that serves at least some data and/or functionality to computer 102. Remote server 108 may be controlled and used by the same entity that operates computer 102. Remote server 108 represents the machine(s) that collect and store helpful and useful data for use by other computers, such as computer 102. For example, in a hypothetical case where computer 102 is designed and programmed to provide a recommendation based on historical data, this historical data may be provided to computer 102 from remote database 138 of remote server 108.

Public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 110 is performed by the computer hardware and/or software of cloud orchestration module 142. The computing resources provided by public cloud 110 are typically implemented by virtual computing environments that run on various computers making up the computers of host physical machine set 144, which is the universe of physical computers in and/or available to public cloud 110. The virtual computing environments (VCEs) typically take the form of virtual machines from virtual machine set 146 and/or containers from container set 148. These VCEs may be stored as images and may be transferred among and between the various physical machine hosts, either as images or after instantiation of the VCE. Cloud orchestration module 142 manages the transfer and storage of images, deploys new instantiations of VCEs, and manages active instantiations of VCE deployments. Gateway 140 is the collection of computer software, hardware, and firmware that allows public cloud 110 to communicate through WAN 104.

Some further explanation of VCEs will now be provided. VCEs can be stored as “images.” A new active instance of a VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 112 is similar to public cloud 110, except that the computing resources are only available for use by a single enterprise. While private cloud 112 is depicted as being in communication with WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this example, public cloud 110 and private cloud 112 are both part of a larger hybrid cloud.

Cloud computing services and/or microservices (not separately shown in FIG. 1): private and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where content is being presented to an internal or external customer in the form of a cloud computing service. As-a-service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with such tasks. Another category is Software-as-a-Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some implementations, a device (e.g., computer 102, computer system) may determine that a first net has experienced a timing failure in a circuit of a circuit system that follows a design style or methodology, such as an HLBS design or system or a very large scale integration (VLSI) design. The device may select a second net in the circuit that has better timing properties than the first net. The device may swap, in a stored netlist, a first net name of the first net a second net name of the second net in association with swapping endpoint connection locations of the first net and endpoint connection locations of the second net. The device may update routing information in the stored netlist to connect endpoints of the first net and endpoints of the second net.

In an example, an HLBS design is a design and synthesis methodology used in digital electronic circuit design, particularly in the design of complex digital systems, such as microprocessors and ASICs (Application-Specific Integrated Circuits). An HLBS system is divided into smaller, more manageable blocks, which are then synthesized and optimized individually. Each block is a large, complex logic circuit that is typically composed of multiple smaller logic gates and interconnects. By breaking down the design into smaller, more manageable blocks, it is easier to design, optimize, and verify the system. Hierarchical blocks can be reused across different designs, reducing the amount of design effort required.

In the context of the HLBS system, a net refers to a single connection or wire that carries a signal between different logic gates, blocks, or components of the digital circuit. Nets can be referred to as “wires” that connect the various logic gates and blocks together, allowing the circuit to function as intended. Input nets carry input signals into a block or logic gate. Output nets carry output signals from a block or logic gate. Internal nets connect logic gates and blocks within a larger block or module. Global nets connect multiple blocks or modules across the entire circuit. Nets in an HLBS can also have different attributes, such as a width, a driver (drives the signal on the net), a load, or timing constraints. However, HLBS blocks may have different timing constraints, power constraints, and area constraints. It may be difficult to meet the required timing constraints, especially where the blocks have complex interactions. An HLBS system may have a timing failure identifier that identifies nets that are failing timing.

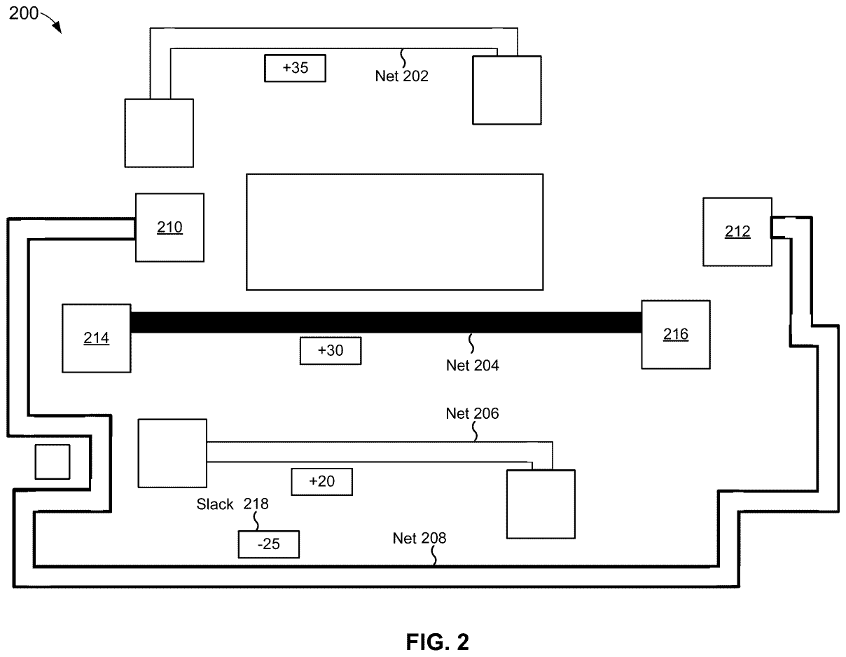

FIG. 2 is a diagram of a portion of circuit of an HLBS 200. There may be multiple nets, such as net 202, net 204, net 205, and net 208 that are each connected at the end points to components (e.g., logic gates, blocks). Traffic may flow on the nets between the components. Each net may have a net name. In the context of digital circuit design, a net name is a unique identifier assigned to a net, which is a connection or wire that carries a signal between various components of the digital circuit. Net names are used to identify and reference specific nets within the design. In the HLBS system, net names are tracked and managed using a netlist, a database or a data structure that stores information about each net, including its name, its connection points, and its properties. A netlist is a text file or database that contains a list of all the nets in the design, along with their properties and connections. The netlist is used to track the net names and their corresponding connections. The database or data structure is updated whenever a change is made to the design, such as when a net is added, deleted, or modified.

Timing slack, also known as slack time or simply slack, is the amount of time by which a signal can be delayed without affecting the overall timing of a digital circuit. In other words, it is the margin of safety between the actual arrival time of a signal and the required arrival time. Timing slack is calculated as the difference between the required arrival time (RAT) and the actual arrival time (AAT) of a signal. The RAT is the latest time by which a signal must arrive at a particular point in the circuit, while the AAT is the actual time at which the signal arrives. A positive timing slack indicates that the signal has arrived at the required point in the circuit before the required arrival time, which means that the circuit will function correctly. On the other hand, a negative timing slack indicates that the signal has arrived after the required arrival time, which can cause timing errors and lead to circuit failure. If there is zero slack, the signal arrives exactly at the required arrival time.

In FIG. 2, net 204 is between components 214 and 216. Net 208 is between components 210 and 212. Net 208 has a slack (slack 218) of −25 (picoseconds (ps)). The signal arrives after the required arrival time. Net 204 has a slack of +30. The signal arrives before the required arrival time. That is, net 208 has a negative timing slack and thus is failing timing. A timing failure may be a slack below a slack threshold.

To fix the timing issue, the HLBS system may swap net 204 and net 208 in a net swap. There are different ways to perform the net swap. The net swap can be performed by deleting net 208 and manually rerouting net 208 to try and find a better path. However, this method is time-consuming and often results in the creation of new timing failures. The net swap can be performed by freezing the surrounding logic and manually rerouting net 208. However, this method is also time-consuming and often results in the creation of new timing failures. A net swap can be performed by manually rerouting net 208 by hand, which is a tedious and error-prone process. In sum, manual rerouting is time-consuming, error-prone, hard to scale, and risks collateral damage.

FIGS. 3A-3C are diagrams illustrating an example implementation 300 associated with net name swapping.

Some implementations of the present disclosure may perform a net swap quicker and with fewer drawbacks by swapping net names for swapped nets. A computer system (e.g., computer 102) may identify a first net that is failing timing and select a second net that has better timing (e.g., more slack). The endpoints of the nets may be disconnected. Endpoints of the first net may be connected to the components to which the endpoints of the second net were connected. Endpoints of the second net may be connected to the components to which the endpoints of the first net were connected. The net names for the nets may be swapped. For example, the new net name for the first net may be the previous net name of the second net, and the new net name for the second net may be the previous net name of the first net. The traffic may be rerouted on the nets using the swapped net names. In this way, the timing slack for the first net improves. The second net is selected such that the timing slack is still sufficient or can be addressed with a subsequent action. For example, the computer system may select the second net such that the timing slack for the second net after the swap remains positive, is above a threshold timing slack, or will be positive after a routing adjustment. The computer system reduces the time that the nets are down, while avoiding actions that could affect the timing elsewhere. As a result, the down time is decreased and the computation time is increased. Processing resources are conserved.

The example implementation 300 in FIGS. 3A-3C illustrates a net name swap for net 204 and net 208 from FIG. 2. As shown by reference number 305 in FIG. 3A, a computer system (e.g., computer 102) may evaluate timing properties of the circuit of the HLBS system. This may include checking the slacks for nets in a netlist. As shown by reference number 310, the system may determine that there is a timing failure at net 208 (slack is −25 in FIG. 2).

The system may select candidate nets to replace net 208. As shown by reference number 315, the system may select candidate nets using a bounding box around a region of the circuit (shown by bounding box 302 in FIG. 3B). The bounding box may be a rectangular region that encloses a set of nets and is typically defined by its coordinates (x, y, width, height). By using a bounding box to search for a net with better timing, the search space is limited to a specific region around the net that is failing timing, which can improve the efficiency of the search process.

The system may evaluate nets within the bounding box. For example, the system may select a random area between the endpoints of net 208. The system may eliminate nets with a negative slack, nets on different use layers, and nets of a different signal type. The system may score the nets based on delay (e.g., slack), wire types, via, and proximity. For example, the computer system may determine a net swap based on a combination of wire types, vias, and corresponding electrical characteristics of a net not satisfying an electrical characteristic threshold. The system may assign a proximity score to a net based on how much the net deviates from an ideal route after observing multiple wire segments of the net, how much of the net is within the bounding box, or wire characteristic similarity. The wire characteristics (e.g., wire layer, wire width, or the combination thereof) indicate the electrical characteristics (e.g., resistance and capacity) of the net. The electrical characteristics may also depend on the length of the net, which is dependent on the route. The system may assign a delay score to the net based on a measured timing, a calculated or estimated timing, and an estimate of the timing after a net swap.

The system may use rules or machine learning to select the replacement net 204. This may include categorizing a set of nets associated with a set of timing failures by the scores or by distance, wire characteristic, and time of flight. Categories of nets may include fix, improve, bad, or good for replacement. The system may then determine a subset of nets with better timing properties (e.g., good nets with more slack) than the set of nets. The subset of nets may be ordered by score. The net swap may also be evaluated in terms of cost of time and resources. The system may then select one of the nets (e.g., net 204), as shown by reference number 320. The system may select net 204 further based on the distance between the source and load of each net and the preferred metal layer, width, and spacing value of the wires in question.

In some aspects, as shown by reference number 325, the system may display candidate nets to be manually selected, and then receive input that indicates the selected net. The system may provide data needed for rerouting with net 204 and for verifying timing constraints.

As shown in FIG. 3B, the net swap (route swap) may be performed. As shown by reference number 330, the endpoints net 204 and net 208 are disconnected. As shown by reference number 335, the endpoints are connected to the components of the other net. For example, net 208 is now connected to components 214 and 216. Net 204 is now connected to components 210 and 212. The netlist or design database may be locked during the net swap.

As shown by reference number 340 of FIG. 3C, the system may swap the net names in the netlist that is stored or represented in a data store. For example, the net name 334 for net 204 is now net name 336, and the net name 336 for net 208 is now net name 334. The system may update the timing constraints for the swapped nets to ensure that the timing constraints are consistent with the new net names. The system may unlock the netlist or design database.

By swapping the connections and net names of net 204 and net 208, the timing of net 208 improves (now a slack of +5 and not−25) in a quicker manner, and is no longer failing its timing requirement or is at least an improvement in the timing slack.

As shown by reference number 345, the system may remove net segments that are not part of the main wire path of net 204 or net 208. Net segments, or twigs, are small, unnecessary wires that are left over after the net swap process. These twigs can cause problems in the circuit, such as creating unnecessary delays or capacitance. The system may identify and remove twigs that are no longer needed in the main path.

As shown by reference number 350, the system may also account for removal of the net segment. This may include using a combination of algorithms and data structures to keep track of the changes made to the circuit. Net segments may be identified and tracked as removed or not removed. The system may update the netlist to reflect the removal of the twigs and the rerouting of the remaining opens. As shown by reference number 355, the system may reroute any remaining opens to ensure that the circuit remains functional. In digital circuit design, an “open” refers to a point in the circuit where a connection or path is not fully established. Remaining opens are the connections or paths that are still not fully connected or routed after the net swap. A remaining open may include an open net or an open circuit. If a connection or path is not fully established, the signal may not be able to propagate correctly, leading to timing errors or other issues. The system reroutes the net or wire to establish a new connection or path. The system may update the timing graph to reflect the changes made to the circuit, including the removal of the twigs and the rerouting of the remaining opens.

As shown by reference number 360, the system may confirm the new timing properties of net 204, net 208, and/or other nets in the area. The system may re-run the timing analysis to ensure that the circuit meets the timing requirements. By accounting for the net swap, removals, and rerouting, the computer 102 ensures that the circuit is properly updated, the timing analysis is accurate, and the nets meet the timing requirement. The system may also display net swap results, including the new timing properties of the new source-wire-load combinations, and allow a designer to manually verify the swap result.

Swapping net names rather than manually rerouting a whole wire has several benefits, including reduced manual effort (simpler and faster process than manually rerouting a whole wire), minimized disruption to surrounding nets, preservation of existing timing, reduced risk of collateral damage, improved efficiency, reduced complexity, improved scalability, reduced risk of error, improved yield, and reduced costs.

FIG. 4 is a flowchart of an example process 400 associated with a net name swap. One or more process blocks of FIG. 4 are performed by a device (e.g., computer 102) and/or by another device or a group of devices separate from or including the device. Additionally, or alternatively, one or more process blocks of FIG. 4 may be performed by one or more components of computer 102, such as processor set 114, communication fabric 116, volatile memory 118, and/or net name swap code 150.

As shown in FIG. 4, process 400 includes determining that a first net has experienced a timing failure in a circuit of a circuit system (e.g., HLBS system) (block 410). For example, the device may determine that a first net has experienced a timing failure in a circuit of a circuit system, as described above.

As further shown in FIG. 4, process 400 includes selecting a second net in the circuit that has better timing properties than the first net (block 420). For example, the device may select a second net in the circuit that has better timing properties than the first net, as described above.

As further shown in FIG. 4, process 400 includes swapping, in a stored netlist, a first net name of the first net a second net name of the second net in association with swapping endpoint connection locations of the first net and endpoint connection locations of the second net (block 430). For example, the device may swap, in a stored netlist, a first net name of the first net a second net name of the second net in association with swapping endpoint connection locations of the first net and endpoint connection locations of the second net, as described above.

As further shown in FIG. 4, process 400 includes updating routing information in the stored netlist to connect endpoints of the first net and endpoints of the second net (block 440). For example, the device may update routing information in the stored netlist to connect endpoints of the first net and endpoints of the second net, as described above.

Process 400 may include additional aspects, such as any single aspect or any combination of aspects described below and/or in connection with one or more other processes described elsewhere herein.

In a first aspect, process 400 includes accounting for removal of any net segments that are no longer part of a main source-to-sink wire path of the first net. This may include updating layout data to account for the removal.

In a second aspect, alone or in combination with the first aspect, process 400 includes rerouting remaining open nets. This may include updating the routing information to reroute open nets.

In a third aspect, alone or in combination with one or more of the first and second aspects, the swapping of the first net name and the second net name includes assigning the first net name to the second net and assigning the second net name to the first net.

In a fourth aspect, alone or in combination with one or more of the first through third aspects, determining that the first net has experienced the timing failure comprises evaluating existing timing properties of the system.

In a fifth aspect, alone or in combination with one or more of the first through fourth aspects, the selecting of the second net comprises searching within a predefined bounding box around the second net.

In a sixth aspect, alone or in combination with one or more of the first through fifth aspects, process 400 includes selecting the second net based on a scoring function associated with wire similarity, proximity, and delay.

In a seventh aspect, alone or in combination with one or more of the first through sixth aspects, process 400 includes confirming that new timing properties of new source-wire-load combinations resulting from swapping the first net name and the second net name are better than timing properties of the system before the swapping.

In an eighth aspect, alone or in combination with one or more of the first through seventh aspects, the selecting of the second net comprises selecting the second net based on a cost function associated with proximity and timing slack.

In a ninth aspect, alone or in combination with one or more of the first through eighth aspects, process 400 includes visually displaying the first net and the second net in association with a manual verification.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

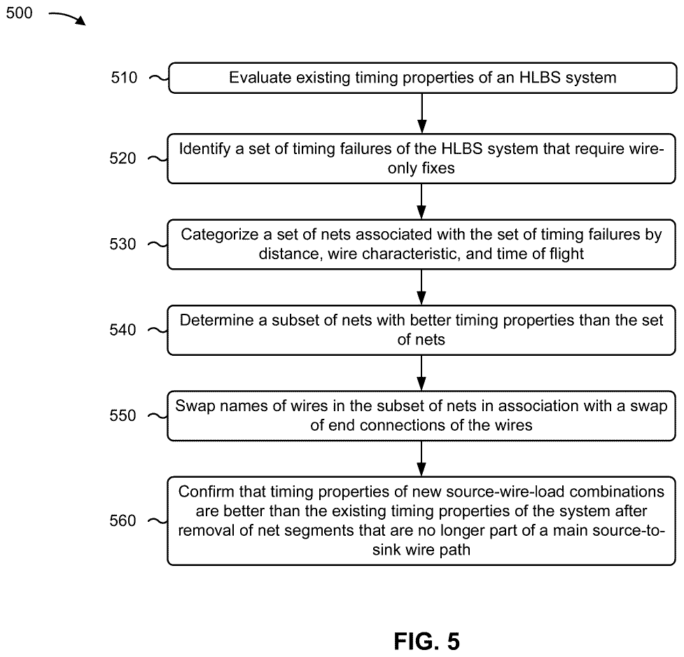

FIG. 5 is a flowchart of an example process 500 associated with a net name swap. One or more process blocks of FIG. 5 are performed by a device (e.g., computer 102) and/or by another device or a group of devices separate from or including the device. Additionally, or alternatively, one or more process blocks of FIG. 4 may be performed by one or more components of computer 102, such as processor set 114, communication fabric 116, volatile memory 118, and/or net name swap code 150.

As shown in FIG. 5, process 500 includes evaluating existing timing properties of a circuit system (block 510). For example, the computer system may evaluate existing timing properties of a circuit system, as described above.

As further shown in FIG. 5, process 500 includes identifying a set of timing failures of the circuit system that require wire-only fixes (block 520). For example, the computer system may identify a set of timing failures of the circuit system that require wire-only fixes, as described above.

As further shown in FIG. 5, process 500 includes categorizing a set of nets associated with the set of timing failures by distance, wire characteristic, and time of flight (block 530). For example, the computer system may categorize a set of nets associated with the set of timing failures by distance, wire characteristic (e.g., wire layer, wire width, or the combination thereof), and time of flight, as described above.

As further shown in FIG. 5, process 500 includes determining a subset of nets with better timing properties than the set of nets (block 540). For example, the computer system may determine a subset of nets with better timing properties than the set of nets, as described above.

As further shown in FIG. 5, process 500 includes swapping names of wires in the subset of nets in association with a swap of end connections of the wires (block 550). For example, the computer system may swap names of wires in the subset of nets in association with a swap of end connections of the wires, as described above.

As further shown in FIG. 5, process 500 includes confirming that timing properties of new source-wire-load combinations are better than the existing timing properties of the system after removal of net segments that are no longer part of the main source-to-sink wire path (block 560). For example, the computer system may confirm that timing properties of new source-wire-load combinations are better than the existing timing properties of the system after removal of net segments that are no longer part of the main source-to-sink wire path, as described above.

Process 500 may include additional aspects, such as any single aspect or any combination of aspects described below and/or in connection with one or more other processes described elsewhere herein.

In a first aspect, the operations further comprise scoring the subset of nets based on delay and wire characteristic similarity.

In a second aspect, alone or in combination with the first aspect, the swapping of names and connections of wires in the subset of nets includes renaming a first net associated with a timing failure to a name of a second net with better timing properties.

In a third aspect, alone or in combination with one or more of the first and second aspects, the operations further comprise searching for new wires in a defined region around a net associated with a timing failure to find a swap candidate.

In a fourth aspect, alone or in combination with one or more of the first through third aspects, the operations further comprise rerouting twigs associated with the wires in the subset of nets to connect to the main source-to-sink wire path.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

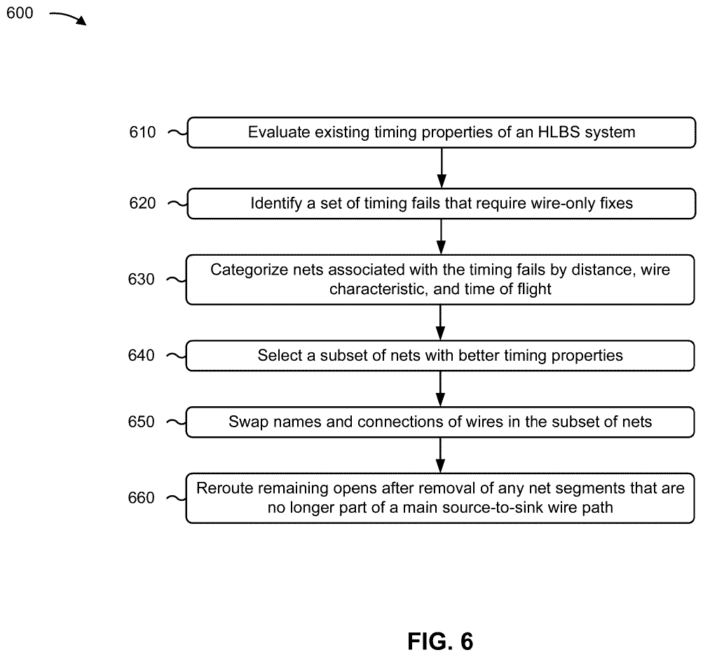

FIG. 6 is a flowchart of an example process 600 associated with a net name swap. One or more process blocks of FIG. 6 are performed by a device (e.g., computer 102) and/or by another device or a group of devices separate from or including the device. Additionally, or alternatively, one or more process blocks of FIG. 4 may be performed by one or more components of computer 102, such as processor set 114, communication fabric 116, volatile memory 118, and/or net name swap code 150.

As shown in FIG. 6, process 600 includes evaluating existing timing properties of an HLBS system (block 610). For example, the device may evaluate existing timing properties of an HLBS system, as described above.

As further shown in FIG. 6, process 600 includes identifying a set of timing failures that require wire-only fixes (block 620). For example, the device may identify a set of timing failures that require wire-only fixes, as described above.

As further shown in FIG. 6, process 600 includes categorizing nets associated with the timing failures by distance, wire characteristic, and time of flight (block 630). For example, the device may categorize nets associated with the timing failures by distance, wire characteristic, and time of flight, as described above.

As further shown in FIG. 6, process 600 includes selecting a subset of nets with better timing properties (block 640). For example, the device may select a subset of nets with better timing properties, as described above.

As further shown in FIG. 6, process 600 includes swapping names and connections of wires in the subset of nets (block 650). For example, the device may swap names and connections of wires in the subset of nets, as described above.

As further shown in FIG. 6, process 600 includes rerouting remaining open nets after removal of any net segments that are no longer part of main source-to-sink wire path (block 660). For example, the device may reroute remaining open nets after removal of any net segments that are no longer part of main source-to-sink wire path, as described above.

Process 600 may include additional aspects, such as any single aspect or any combination of aspects described below and/or in connection with one or more other processes described elsewhere herein.

In a first aspect, the evaluating of the existing timing properties includes determining a timing slack for each net.

In a second aspect, alone or in combination with the first aspect, the categorizing of the nets includes calculating a delay score for each net based on wire characteristic and time of flight.

In a third aspect, alone or in combination with one or more of the first and second aspects, the swapping of the names and the connections of the wires includes renaming a first net to a name of a second net of the subset of nets and renaming the second net to a name of the first net.

In a fourth aspect, alone or in combination with one or more of the first through third aspects, the swapping is associated with an Eco for the wires in the HLBS system.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
determining that a first net has experienced a timing failure in a circuit of a circuit system;
selecting a second net in the circuit that has better timing properties than the first net;
swapping, in a stored netlist, a first net name of the first net and a second net name of the second net in association with swapping endpoint connection locations of the first net and endpoint connection locations of the second net; and
updating routing information in the stored netlist to connect endpoints of the first net and endpoints of the second net.

2. The method of claim 1, further comprising:
updating layout data to account for removal of any net segments that are no longer part of a main source-to-sink wire path of the first net.

3. The method of claim 1, further comprising:
updating the routing information to reroute remaining open nets.

4. The method of claim 1, wherein the swapping of the first net name and the second net name includes assigning the first net name to the second net and assigning the second net name to the first net.

5. The method of claim 1, wherein the determining that the first net has experienced the timing failure comprises evaluating existing timing properties of the system.

6. The method of claim 1, wherein the selecting of the second net comprises searching within a predefined bounding box around the second net.

7. The method of claim 1, further comprising selecting the second net based on a scoring function associated with wire similarity, proximity, and delay.

8. The method of claim 1, further comprising:
confirming that new timing properties of new source-wire-load combinations resulting from swapping the first net name and the second net name are better than timing properties of the system before the swapping.

9. The method of claim 1, wherein the selecting of the second net comprises selecting the second net based on a cost function associated with proximity and timing slack.

10. The method of claim 1, further comprising:
visually displaying the first net and the second net in association with a manual verification.

11. A computer system, comprising:
a processor set;
one or more computer-readable storage media; and
program instructions stored on the one or more computer-readable storage media to cause the processor set to perform operations comprising:
evaluating existing timing properties of a circuit system;
identifying a set of timing failures of the circuit system that require wire-only fixes;
categorizing a set of nets associated with the set of timing failures by distance, wire characteristic, and time of flight;
determining a subset of nets with better timing properties than the set of nets;
swapping names of wires in the subset of nets in association with a swap of end connections of the wires; and
confirming that timing properties of new source-wire-load combinations are better than the existing timing properties of the system after removal of net segments that are no longer part of a main source-to-sink wire path.

12. The computer system of claim 11, wherein the operations further comprise:
scoring the subset of nets based on delay and wire characteristic similarity.

13. The computer system of claim 11, wherein the swapping of names and connections of wires in the subset of nets includes renaming a first net associated with a timing failure to a name of a second net with better timing properties.

14. The computer system of claim 11, wherein the operations further comprise:
searching for new wires in a defined region around a net associated with a timing failure to find a swap candidate.

15. The computer system of claim 11, wherein the operations further comprise:
rerouting twigs associated with the wires in the subset of nets to connect to the main source-to-sink wire path.

16. A computer program product, comprising:
one or more computer-readable storage media; and
program instructions stored on the one or more computer-readable storage media to perform operations comprising:
evaluating existing timing properties of a hierarchical large block synthesis (HLBS) system;
identifying a set of timing failures that require wire-only fixes;
categorizing nets associated with the timing failures by distance, wire characteristic, and time of flight;
selecting a subset of nets with better timing properties;
swapping names and connections of wires in the subset of nets; and
rerouting remaining open nets after removal of any net segments that are no longer part of a main source-to-sink wire path.

17. The computer program product of claim 16, wherein the evaluating of the existing timing properties includes determining a timing slack for each net.

18. The computer program product of claim 16, wherein the categorizing of the nets includes calculating a delay score for each net based on wire characteristic and time of flight.

19. The computer program product of claim 16, wherein the swapping of the names and the connections of the wires includes renaming a first net to a name of a second net of the subset of nets and renaming the second net to a name of the first net.

20. The computer program product of claim 16, wherein the swapping is associated with an engineering change order for the wires in the HLBS system.
